(19) United States
(12) Patent Application Publication
(10) Pub. No.: US 2013/0342991 A1
(43) Pub. Date: Dec. 26, 2013

(54) SERVER RACK

(71) Applicant: ZHENG-HENG SUN, New Taipei (TW)

(72) Inventor: ZHENG-HENG SUN, New Taipei (TW)

(21) Appl. No.: 13/678,551

(22) Filed: Nov. 16, 2012

(30) Foreign Application Priority Data
Jun. 20, 2012 (CN) 2012102046104

(51) Int. Cl. G06F 1/20

(52) U.S. Cl. CPC G06F 1/20
USPC 361/679.46

(57) ABSTRACT

A server rack includes a rack, a first electronic device, a second electronic device, and an air block plate. The first electronic device is mounted in the front of the rack and arranged close to a left side of the rack. An opening is defined between the first electronic device and a right side of the rack. The second electronic device is mounted in the rear of the rack and arranged on a same level with the first electronic device. The air block plate is slantingly connected between the first electronic device and the second electronic device. A first end of the air block plate is connected to a right end of the first electronic device, and a second end of the air block plate opposite to the first end is connected to a left end of the second electronic device.

### BACKGROUND

1. Technical Field

The present disclosure relates to a server rack.

2. Description of Related Art

Typically, a number of electronic devices, such as servers, storages, and switches, are mounted in different levels of a server rack. Sometimes, to save space, two small electronic devices, such as two switches, are mounted on a same level of the server rack. However, due to their small sizes and irregular spaces formed between them, heat produced by the two electronic devices cannot be dissipated effectively.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a partial, assembled, isometric view of a server rack, wherein the server rack includes a server, a first electronic device, a second electronic device, and an air block plate.

FIG. 2 is a partially exploded, isometric view of FIG. 1.

FIG. 3 is an exploded, isometric view of the first electronic device, the second electronic device, and the air block plate of FIG. 2 from another perspective.

FIG. 4 is a top plan view of the server, the first electronic device, the second electronic device, and the air block plate of FIG. 1 together with a plurality of cables.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

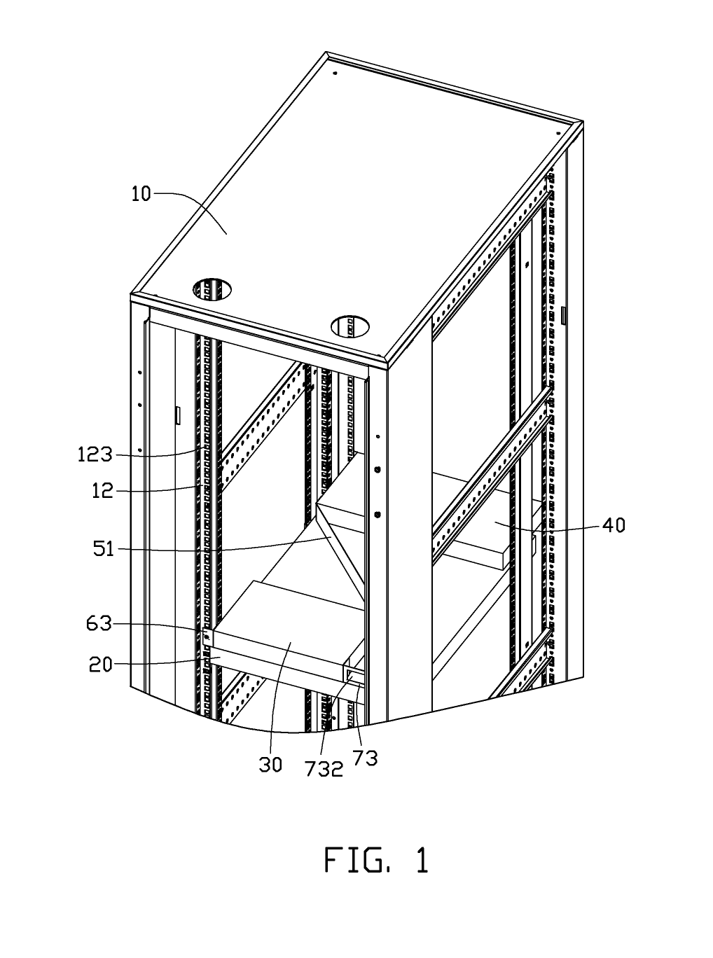

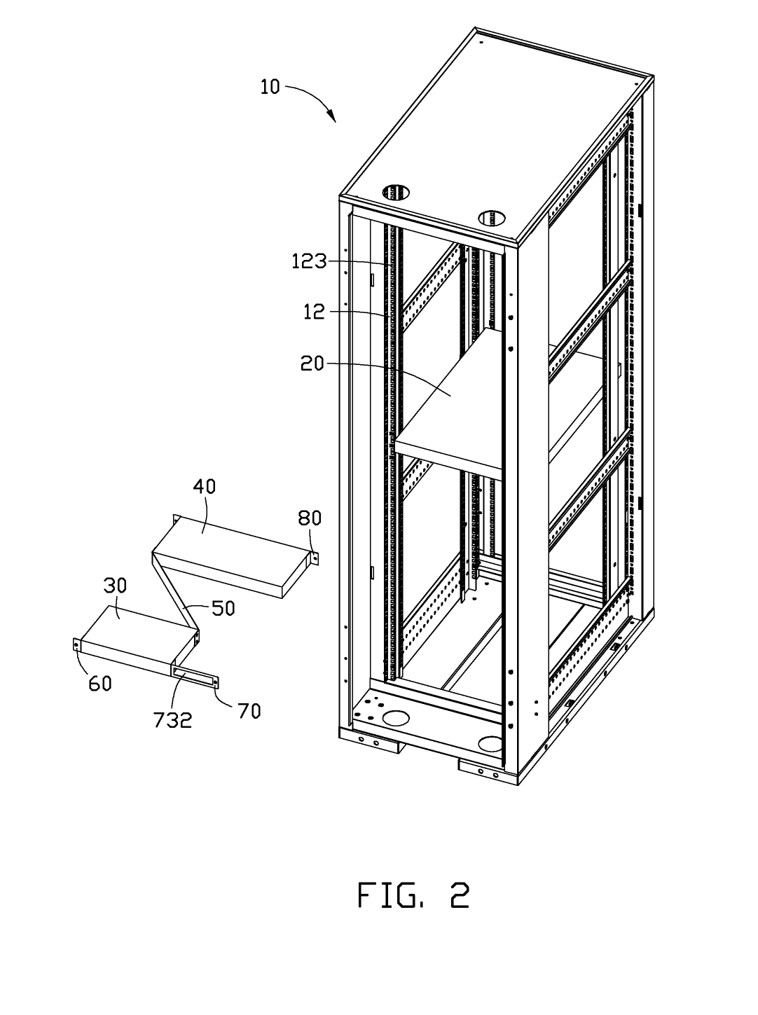

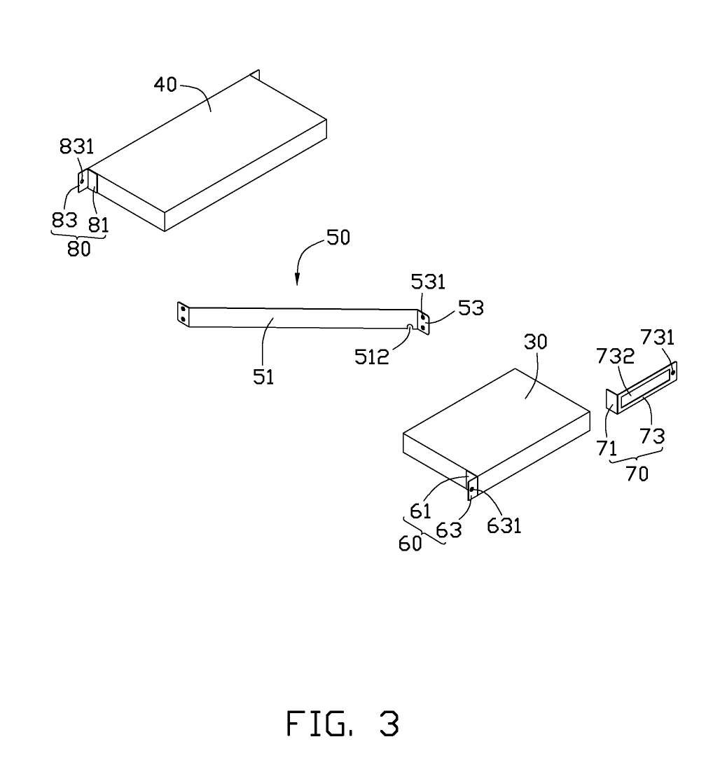

FIGS. 1 to 3 show an embodiment of a server rack. The server rack includes a rack 10, a plurality of servers 20 (only one server 20 is shown), a first electronic device 30, a second electronic device 40, a first mounting member 60, a second mounting member 70, two third mounting members 80, and an air block plate 50.

The rack 10 include four upright posts 12 located in four corners of the rack 10. A plurality of vertically spaced fixing holes 123 is defined in each post 12. The servers 20 are mounted in the rack 10 and spaced vertically.

In the embodiment, the first electronic device 30 is a computer for managing the servers 20, the second electronic device 40 is a switch. The sum of widths of the first and second electronic devices 30 and 40 is less than a length of the rack 10. A length of the first electronic device 30 is less than a length of the second electronic device 40. Heights of the first and second electronic devices 30 and 40 are both one unit (U).

The first and second mounting members 60 and 70 are respectively fixed to left and right ends of the first electronic device 30, adjacent to the front side of the first electronic device 30. The first mounting member 60 includes a tab 61 fixed to the left end of the first electronic device 30, and a first mounting plate 63 perpendicularly extending toward the left end from the front end of the tab 61 and coplanar with the front side of the first electronic device 30. A through hole 631 is defined in the first mounting plate 63. The second mounting member 70 includes a tab 71 fixed to the right end of the first electronic device 30, and a second mounting plate 73 perpendicularly extending toward the right end from the front end of the tab 71 and coplanar with the front side of the first electronic device 30. A through hole 731 is defined in the second mounting plate 73 away from the tab 71. A long opening 732 is defined in the second mounting plate 73, between the tab 71 and the through hole 731.

The through holes 631 and 731 are respectively aligned with two fixing holes 123 of two front posts 12 of the rack 10 on a same level. Two screws extend through the through holes 631 and 731 and engage in the two corresponding fixing holes 123, to lock the first and second mounting plates 63 and 73 to the front posts 12. Thereby, the first electronic device 30 is mounted in the front of the rack 10. The first electronic device 30 is close to the left side of the rack 10. The opening 732 is arranged between the first electronic device 30 and the post 12 at the front right side of the rack 10.

The third mounting members 80 are respectively fixed to left and right ends of the rear side of the second electronic device 40. Each third mounting member 80 includes a tab 81 fixed to the corresponding one of the left and right ends of the second electronic device 40, and a third mounting plate 83 perpendicularly extending out from the rear end of the tab 81 and coplanar with the rear side of the second electronic device 40. A through hole 831 is defined in each third mounting plate 83.

The through holes 831 are respectively aligned with two fixing holes 123 of two rear posts 12 of the rack 10, on a same level with the first electronic device 30. Two screws extend through the through holes 831 and engage in the two corresponding fixing holes 123, to lock the third mounting plates 83 to the rear posts 12. Thereby, the second electronic device 40 is mounted in the rear of the rack 10, and arranged on a same level with the first electronic device 30.

The air block plate 50 includes an elongated main plate 51, and two parallel end plates 53 slantingly extending away from each other from opposite ends of the main plate 51. A notch 512 is defined in the bottom of the main plate 51 adjacent to one of the end plates 53. Two through holes 531 are defined in each end plate 53.

Two screws extend through the through holes 531 of one of the end plates 53 adjacent to the notch 512, and engage in the right end of the first electronic device 30 adjacent to the rear side of the first electronic device 30, to fix the end plate 53 to the first electronic device 30. Two screws extend through the through holes 531 of the other end plate 53, and engage in the left end of the second electronic device 40 adjacent to the front side of the second electronic device 40, to fix the other end plate 53 to the second electronic device 40. Thereby, the air block plate 50 is slantingly connected between the first and second electronic devices 30 and 40.

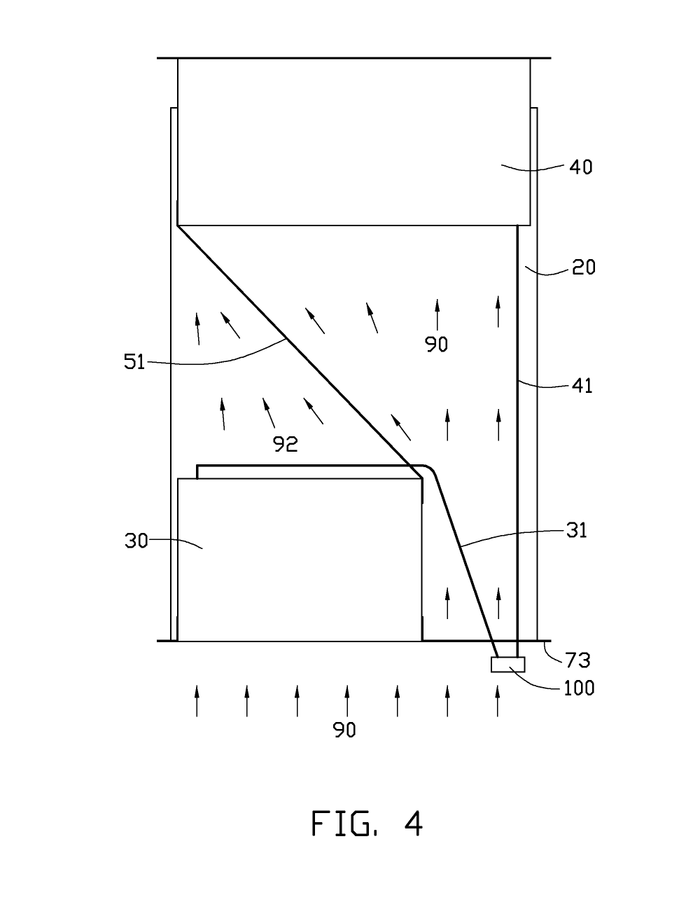

Referring to FIG. 4, cables 31 connected to the rear side of the first electronic device 30 extend through the notch 512 and the opening 732, and is connected to a power distribution unit 100. Cables 41 connected to the front side of the second electronic device 40 extend through the opening 732, and is connected to the power distribution unit 100.

When the server rack operates, cool air 90 is blown backwards into the rack 10 from the front side of the rack 10. Some of the cool air 90 is blown towards the first electronic device 30, and dissipates heat for the first electronic device 30. The other cool air 90 extends through the opening 732, and is directly blown towards the second electronic device 40, to dissipate heat for the second electronic device 40. The main plate 51 is slantingly arranged between the first and second electronic devices 30 and 40, which will guide hot air 92 produced by the first electronic device 30 to flow to outside from the left side of the rack 10, and to prevent the hot air 92 from flowing towards the second electronic device 40.

In other embodiments, a plurality of shelves is mounted in the rack at different heights, the first electronic device 30, the air block plate 50, and the second electronic device 40 are directly placed on one of the shelves. Therefore, the first, second, and third mounting members 60, 70, and 80 can be omitted.

In other embodiments, the second electronic device 40 is located closer to the right side of the rack 10, which allows more cool air 90 to be blown on the second electronic device 40 from the opening 732.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A server rack, comprising:
a rack;
a first electronic device mounted in a front of the rack, wherein the first electronic device is arranged close to a left side of the rack, and an opening is defined between the first electronic device and a right side of the rack;
a second electronic device mounted in a rear of the rack and arranged on a same level with the first electronic device; and
an air block plate slantingly connected between the first electronic device and the second electronic device, wherein a first end of the air block plate is connected to a right end of the first electronic device, and a second end of the air block plate opposite to the first end is connected to a left end of the second electronic device.

2. The server rack of claim 1, further comprising a first mounting member fixed to a left end of the first electronic device adjacent to a front side of the first electronic device, and a second mounting member fixed to the right end of the first electronic device adjacent to the front side of the first electronic device, wherein the rack comprises four upright posts located in four corners of the rack, the first mounting member comprises a first mounting plate fixed to one of the posts at a front left corner of the rack, the second mounting member comprises a second mounting plate fixed to another one of the posts at a front right corner of the rack, the opening is defined in the second mounting plate.

3. The server rack of claim 2, wherein the air block plate comprises an elongated main plate, and two parallel end plates slantingly extending away from each other from opposite ends of the main plate, one of the end plates is connected to the right end of the first electronic device adjacent to a rear side of the first electronic device, and the other end plate is connected to the left end of the second electronic device adjacent to a front side of the second electronic device.

4. The server rack of claim 3, wherein a notch is defined in the main plate adjacent to the first electronic device, for allowing cables connected to the rear side of the first electronic device to extend through.

5. The server rack of claim 4, wherein the cables connected to the rear side of the first electronic device extend through the notch and then extend through the opening of the second mounting plate.

6. The server rack of claim 2, wherein cables connected to the front side of the second electronic device extend through the opening of the second mounting plate.

7. The server rack of claim 1, wherein heights of the first and second electronic devices are both one unit (U).

8. The server rack of claim 7, wherein the first electronic device is a computer for managing servers, and the second electronic device is a switch.

9. The server rack of claim 1, wherein the second electronic device is arranged close to the right side of the rack.
